(19) United States
(12) Patent Application Publication
(10) Pub. No.: US 2019/0355258 A1
(43) Pub. Date: Nov. 21, 2019

(54) INFORMATION PROCESSING DEVICE, INFORMATION PROCESSING METHOD, AND COMPUTER READABLE MEDIUM

(71) Applicant: Mitsubishi Electric Corporation, Tokyo (JP)

(72) Inventor: Toru KIMURA, Tokyo (JP)

(73) Assignee: Mitsubishi Electric Corporation, Tokyo (JP)

(21) Appl. No.: 16/468,840

(22) PCT Filed: Feb. 9, 2017
(86) PCT No.: PCT/JP2017/004695

§ 371 Date: Jun. 12, 2019

(51) Int. Cl. G08G 1/00; G08G 1/0967; G08G 1/01; H04W 4/46

(52) U.S. Cl. CPC G08G 1/20; G08G 1/096733; H04W 4/46; G08G 1/0137; G08G 1/096775

(57) ABSTRACT

A grouping unit (1131) groups a plurality of vehicles travelling in a same direction, on each of which an on-vehicle device is mounted, and notifies each of a plurality of on-vehicle devices of the plurality of vehicles of a fact that a vehicle on which each on-vehicle device is mounted belongs to a vehicle group. A reception unit (111) receives a disbandment request for requesting disbandment of the vehicle group, from an on-vehicle device of a quitting vehicle whose travelling direction has become different from that of other vehicles of the plurality of vehicles, among the plurality of on-vehicle devices. A group disbandment unit (1132) disbands the vehicle group when the disbandment request is received by the reception unit (111).

### TECHNICAL FIELD

The present invention relates to a technique of grouping travelling vehicles.

### BACKGROUND ART

There has been considered a technique in which a driving recorder mounted in a vehicle captures images around the vehicle when it is travelling and an on-vehicle mounted in the vehicle transmits the captured images to a server device in a management center so as to use the images for investigation and an inquiry into the cause at a time of a traffic accident. In this case, when the number of vehicles travelling on a road increases due to a traffic jam and the like, the volume of communication from the vehicles to the server device increases and the communication cost therefor also increases.

A method of suppressing the increase of communication volume due to the increase of the number of vehicles is disclosed in Patent Literature 1. Specifically, in Patent Literature 1, there is disclosed a technique in which a probe information center performs grouping of vehicles that are in similar travelling conditions on the basis of probe information transmitted from an on-vehicle communication device incorporated in a vehicle PC (Personal Computer). In the method of Patent Literature 1, a representative vehicle is selected for each vehicle group. Further, in the method of Patent Literature 1, a server device in the probe information center collects probe information transmitted from the selected representative vehicle. In the method of Patent Literature 1, after grouping has been performed, probe information of the representative vehicle is recognized as probe information of the entire vehicle group to which the representative vehicle belongs.

### CITATION LIST

### Patent Literature

Patent Literature 1: JP 2012-89088

### SUMMARY OF INVENTION

### Technical Problem

In Patent Literature 1, the server device in the probe information center determines whether the travelling conditions of vehicles belonging to a vehicle group have changed, and determines whether to disband the vehicle group. As described above, after forming a vehicle group, only probe information of a representative vehicle is transmitted to the server device in the probe information center. Therefore, the server device in the probe information center uses only the probe information of the representative vehicle to determine whether the travelling conditions of the vehicles belonging to the vehicle group have changed. That is, probe information of other vehicles in the vehicle group is not used to determine whether the travelling conditions of the vehicles belonging to the vehicle group have changed.

A case where the travelling direction of a vehicle other than a representative vehicle in a vehicle group has taken a direction different from the travelling direction of other vehicles in the vehicle group is considered here. For example, a case where a vehicle has made any of a left turn, a right turn, and a U-turn to travel in a direction different from the direction of other vehicles in the vehicle group is considered. In this manner, when the travelling direction of a vehicle in the vehicle group has become different from the travelling direction of other vehicles, the travelling conditions of the vehicle is not reflected in the probe information of the representative vehicle. Therefore, the server device in the probe information center needs to disband the vehicle group to collect probe information from each of the vehicles individually.

However, since the server device in the probe information center in Patent Literature 1 collects only the probe information of the representative vehicle, it is not possible to detect a fact that a part of the vehicles in the vehicle group has taken a travelling activity that is different from that of other vehicles. Therefore, in Patent Literature 1, there is a problem that the server device in the probe information center cannot disband the vehicle group in a situation where the vehicle group is supposed to be disbanded.

The present invention has a main object to solve the problem described above.

Specifically, the main object of the present invention is to obtain a configuration in which, when a vehicle in a vehicle group travels in a direction different from a direction of other vehicles in the vehicle group, the vehicle group is disbanded securely and it is possible to switch to collection of probe information from each vehicle.

### Solution to Problem

An information processing device according to the present invention includes:

a grouping unit to group a plurality of vehicles travelling in a same direction, on each of which an on-vehicle device is mounted, and to notify each of a plurality of on-vehicle devices of the plurality of vehicles of a fact that a vehicle on which each on-vehicle device is mounted belongs to a vehicle group;

a reception unit to receive a disbandment request for requesting disbandment of the vehicle group, from an on-vehicle device of a quitting vehicle whose travelling direction has become different from that of other vehicles of the plurality of vehicles, among the plurality of on-vehicle devices; and

a group disbandment unit to disband the vehicle group when the disbandment request is received by the reception unit.

### Advantageous Effects of Invention

In the present invention, a vehicle group is disbanded when a disbandment request is transmitted from an on-vehicle device of a quitting vehicle. Therefore, according to the present invention, when a vehicle in a vehicle group travels in a direction different from a direction of other vehicles in the vehicle group, the vehicle group is disbanded securely and it is possible to switch to collection of probe information from each vehicle.

### BRIEF DESCRIPTION OF DRAWINGS

FIG. 1 is a diagram illustrating a configuration example of a probe-information collecting system according to a first embodiment.

FIG. 2 is a diagram illustrating a hardware configuration example of a server device according to the first embodiment.

FIG. 3 is a diagram illustrating a functional configuration example of the server device according to the first embodiment.

FIG. 4 is a diagram illustrating a hardware configuration example of an on-vehicle device according to the first embodiment.

FIG. 5 is diagram illustrating a functional configuration example of the on-vehicle device according to the first embodiment.

FIG. 6 is a flowchart illustrating an operation example of the server device according to the first embodiment.

FIG. 7 is a flowchart illustrating an operation example of the server device according to the first embodiment.

FIG. 8 is a flowchart illustrating an operation example of the on-vehicle device according to the first embodiment.

FIG. 9 is a diagram illustrating a setting example of a grouping candidate range according to the first embodiment.

FIG. 10 is a diagram illustrating transmission status of probe information of each vehicle according to the first embodiment.

FIG. 11 is a flowchart illustrating an operation example of a server device according to a second embodiment.

FIG. 12 is a flowchart illustrating an operation example of an on-vehicle device according to the second embodiment.

FIG. 13 is a diagram illustrating transmission status of probe information of each vehicle according to the second embodiment.

### DESCRIPTION OF EMBODIMENTS

Embodiments of the present invention will be explained below with reference to the drawings. In the following descriptions of the embodiments and the drawings, elements denoted by the same reference signs indicate the same or corresponding parts.

First embodiment.

### ***DESCRIPTIONS OF CONFIGURATIONS***

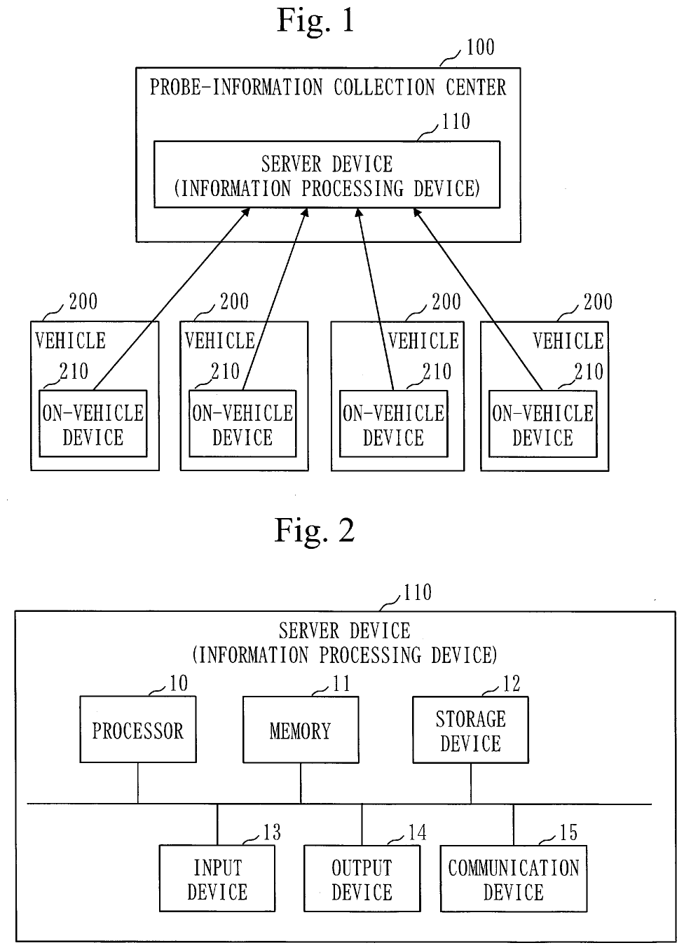

FIG. 1 illustrates a configuration example of a probe-information collecting system according to the present embodiment.

As illustrated in FIG. 1, the probe-information collecting system according to the present embodiment includes a probe-information collection center 100 and a plurality of vehicles 200. The probe-information collection center 100 includes a server device 110. Each of the vehicles 200 includes an on-vehicle device 210.

The on-vehicle device 210 transmits probe information to the server device 110. For example, images captured by the on-vehicle device 210 and positional information and speed information of the vehicle 200 are included in the probe information. In the following descriptions, “the on-vehicle device 210 transmits probe information” is also expressed as “the vehicle 200 transmits probe information” for convenience.

The server device 110 collects probe information transmitted from the on-vehicle device 210 and accumulates the collected probe information.

The server device 110 corresponds to an information processing device. Operations performed by the server device 110 correspond to an information processing method and an information processing program.

Operations performed by the on-vehicle device 210 correspond to a communication method and a communication program.

FIG. 2 illustrates a hardware configuration example of the server device 110.

The server device 110 is a computer.

The server device 110 includes, as hardware, a processor 10, a memory 11, a storage device 12, an input device 13, an output device 14, and a communication device 15. The processor 10, the memory 11, the storage device 12, the input device 13, the output device 14, and the communication device 15 are connected via a system bus.

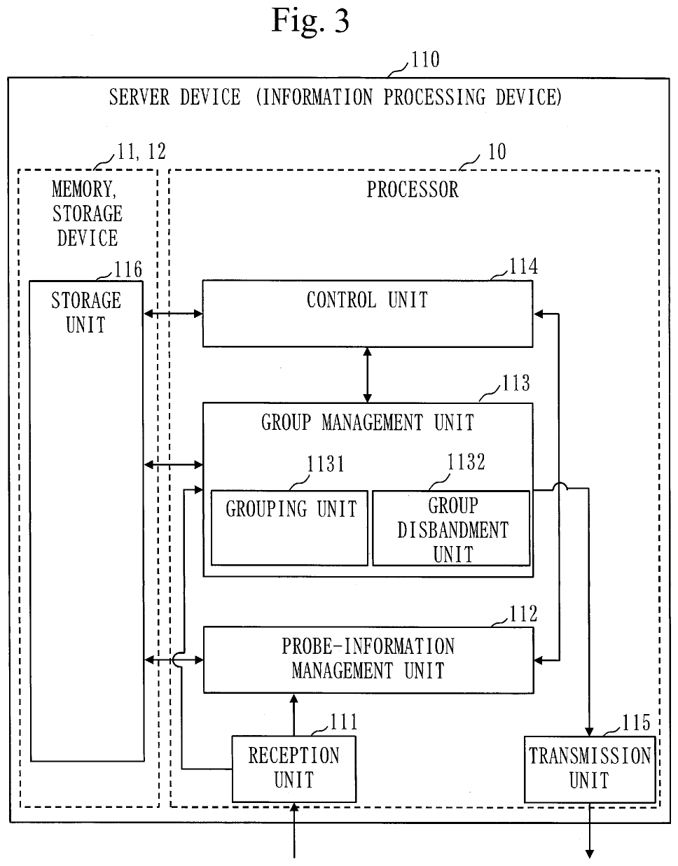

The storage device 12 stores therein a program for realizing the functions of a reception unit 111, a probe-information management unit 112, a group management unit 113, a control unit 114, and a transmission unit 115 that are described later with reference to FIG. 3. The program is loaded in the memory 11. Subsequently, the program is read in the processor 10 from the memory 11 and is executed by the processor 10.

The processor 10executes the program, and operations of the reception unit 111, the probe-information management unit 112, the group management unit 113, the control unit 114, and the transmission unit 115 described later are performed.

The input device 13 is a keyboard or a mouse, for example. The input device 13 is used when a user of the server device 110 inputs various types of data.

The output device 14 is a display device, for example. The output device 14 is used to present various types of information to the user of the server device 110.

While the server device 110 can be provided as a dedicated device, the server device 110 can be also realized by using a personal computer, for example.

FIG. 3 illustrates a functional configuration example of the server device 110.

As a functional configuration, the server device 110 includes the reception unit 111, the probe-information management unit 112, the group management unit 113, the control unit 114, the transmission unit 115, and a storage unit 116.

The reception unit 111 receives probe information transmitted from the on-vehicle device 210. The reception unit 111 transfers the received probe information to the probe-information management unit 112. Further, the reception unit 111 receives a disbandment request for requesting disbandment of a vehicle group. The reception unit 111 then transfers the received disbandment request to the group management unit 113. Details of the vehicle group and the disbandment request are described later.

Operations performed by the reception unit 111 correspond to a reception process.

The probe-information management unit 112 stores the probe information received by the reception unit 111 in the storage unit 116.

The group management unit 113 manages a vehicle group.

The group management unit 113 includes a grouping unit 1131 and a group disbandment unit 1132.

The grouping unit 1131 groups a plurality of vehicles 200 travelling in the same direction. Specifically, the grouping unit 1131 designates an arbitrary vehicle 200 travelling in a specific direction as a representative vehicle. Subsequently, the grouping unit 1131 calculates the density of vehicles 200 that are travelling in the specific direction and included in a grouping candidate range that is a range within a predetermined distance from the representative vehicle. When the calculated density is equal to or higher than a reference density, the grouping unit 1131 determines that a traffic-congested state has occurred, and groups the plurality of vehicles 200 including the representative vehicle that are included in the grouping candidate range and travelling in the specific direction.

Further, the grouping unit 1131 sets a transmission order of probe information to a plurality of on-vehicle devices 210 of the plurality of vehicles 200 included in the vehicle group that is obtained by the grouping.

The grouping unit 1131 then notifies each on-vehicle device 210 of a fact that the vehicle 200 on which each on-vehicle device 210 is mounted belongs to the vehicle group. Further, the grouping unit 1131 notifies each on-vehicle device 210 of the transmission order of probe information.

Operations performed by the grouping unit 1131 correspond to a grouping process.

When a disbandment request is received by the reception unit 111, the group disbandment unit 1132 disbands the vehicle group.

Operations performed by the group disbandment unit 1132 correspond to a group disbandment process.

The control unit 114 controls the reception unit 111, the probe-information management unit 112, the group management unit 113, the transmission unit 115, and the storage unit 116 that are included in the server device 110.

The transmission unit 115 transmits a vehicle group notification to each on-vehicle device 210. The vehicle group notification is a message for notifying each on-vehicle device 210 of a fact that the vehicle 200 on which each on-vehicle device 210 is mounted belongs to a vehicle group and a transmission order of probe information of each on-vehicle device 210.

Further, the transmission unit 115 transmits a group disbandment notification to the respective on-vehicle devices 210. The group disbandment notification is a message for notifying each on-vehicle device 210 of a fact that the vehicle group to which the vehicle on which each on-vehicle device 210 is mounted has belonged has been disbanded.

FIG. 2 schematically illustrates a state where the processor 10 is executing a program for realizing the functions of the reception unit 111, the probe-information management unit 112, the group management unit 113, the control unit 114, and the transmission unit 115.

The storage unit 116 stores therein probe information and vehicle group information.

In the vehicle group information, identifiers of the respective vehicles 200 belonging to a vehicle group and communication addresses allocated to the respective on-vehicle devices 210 are described for each vehicle group.

The storage unit 116 is realized by the memory 11 or the storage device 12.

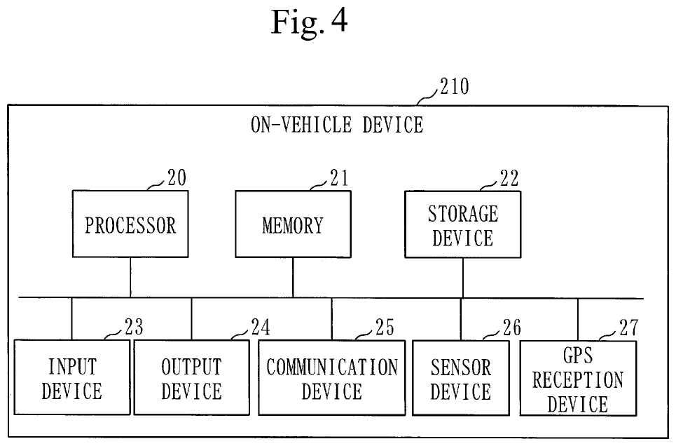

FIG. 4 illustrates a hardware configuration example of the on-vehicle device 210 according to the present embodiment.

The on-vehicle device 210 is a computer.

The on-vehicle device 210 includes, as hardware, a processor 20, a memory 21, a storage device 22, an input device 23, an output device 24, a communication device 25, a sensor device 26, and a GPS (Global Positioning System) reception device 27.

The processor 20, the memory 21, the storage device 22, the input device 23, the output device 24, the communication device 25, the sensor device 26, and the GPS reception device 27 are connected via a system bus.

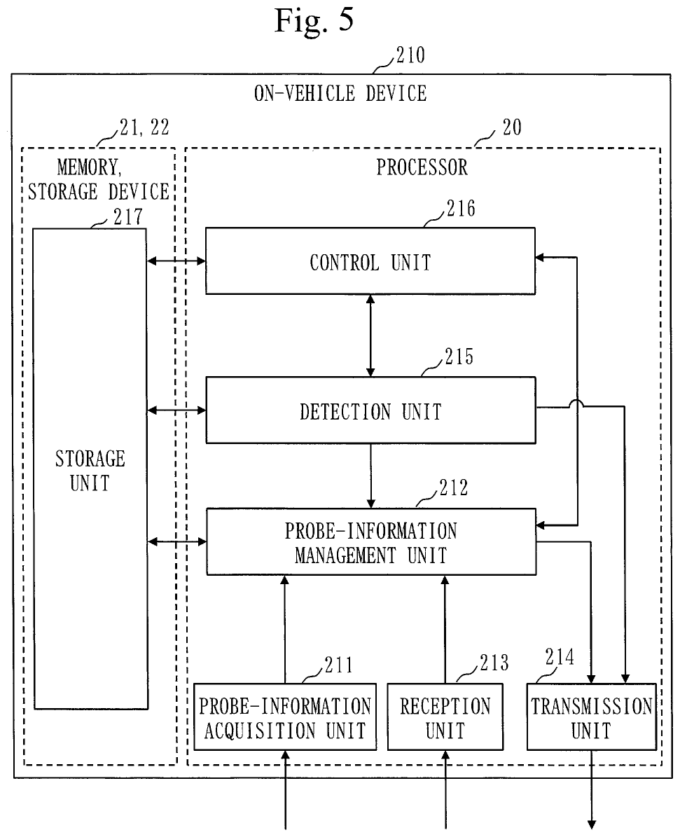

The storage device 22 stores a program for realizing the functions of a probe-information acquisition unit 211, a probe-information management unit 212, a reception unit 213, a transmission unit 214, a detection unit 215, and a control unit 216 that are described later with reference to FIG. 5. The program is loaded in the memory 21. Subsequently, the program is read in the processor 20 from the memory 21 and is executed by the processor 20.

The processor 20 executes the program, and operations of the probe-information acquisition unit 211, the probe-information management unit 212, the reception unit 213, the transmission unit 214, the detection unit 215, and the control unit 216 described later are performed.

The input device 23 is a touch panel or a switch button, for example. The input device 23 is used when a user of the on-vehicle device 210 inputs various types of data.

The output device 24 is a display device or an LED (Light Emitting Diode) lamp, for example. The output device 24 is used to present the operating state of the on-vehicle device 210 and the like to the user of the on-vehicle device 210.

The sensor device 26 is a camera or a microphone, for example. The camera is used to capture images around the vehicle 200. The microphone is used to pick up the sound around the vehicle 200.

The GPS reception device 27 measures the position of the vehicle 200.

Probe information such as the images captured by the camera, the sound picked up by the microphone, and the position and speed of the vehicle 200 measured by the GPS reception device 27 is stored in the storage device 22.

FIG. 5 illustrates a functional configuration example of the on-vehicle device 210 according to the present embodiment.

As a functional configuration, the on-vehicle device 210 includes the probe-information acquisition unit 211, the probe-information management unit 212, the reception unit 213, the transmission unit 214, the detection unit 215, the control unit 216, and a storage unit 217.

The probe-information acquisition unit 211 acquires probe information. The probe-information acquisition unit 211 acquires probe information from, for example, a camera, a microphone or the like. Subsequently, the probe-information acquisition unit 211 transfers the acquired probe information to the probe-information management unit 212.

The probe-information management unit 212 stores the probe information in the storage unit 217. When a transmission timing of the probe information arrives, the probe-information management unit 212 reads the probe information from the storage unit 217 and transfers the read probe information to the transmission unit 214.

When a vehicle group is formed in the server device 110, the reception unit 213 receives a vehicle group notification from the server device 110.

Further, when the vehicle group is disbanded in the server device 110, the reception unit 213 receives a group disbandment notification.

Operations performed by the reception unit 213 correspond to a reception process.

The detection unit 215 detects a fact that, as a vehicle 200 on which the on-vehicle device 210 is mounted has changed its travelling direction, the vehicle 200 is travelling in a direction different from the travelling direction of other vehicles 200 that belong to a vehicle group.

Subsequently, upon detection of the fact that the vehicle 200 on which the on-vehicle device 210 is mounted is travelling in the direction different from the travelling direction of other vehicles 200 that belong to the vehicle group, the detection unit 215 instructs the transmission unit 214 to transmit a disbandment request.

Operations performed by the detection unit 215 correspond to a detection process.

The transmission unit 214 transmits a disbandment request to the server device 110 based on the instruction from the detection unit 215.

Operations performed by the transmission unit 214 correspond to a transmission process.

The control unit 216 controls the probe-information acquisition unit 211, the probe-information management unit 212, the reception unit 213, the transmission unit 214, the detection unit 215, and the storage unit 217.

The storage unit 217 stores therein probe information.

Next, operations of the probe-information collecting system according to the present embodiment are described.

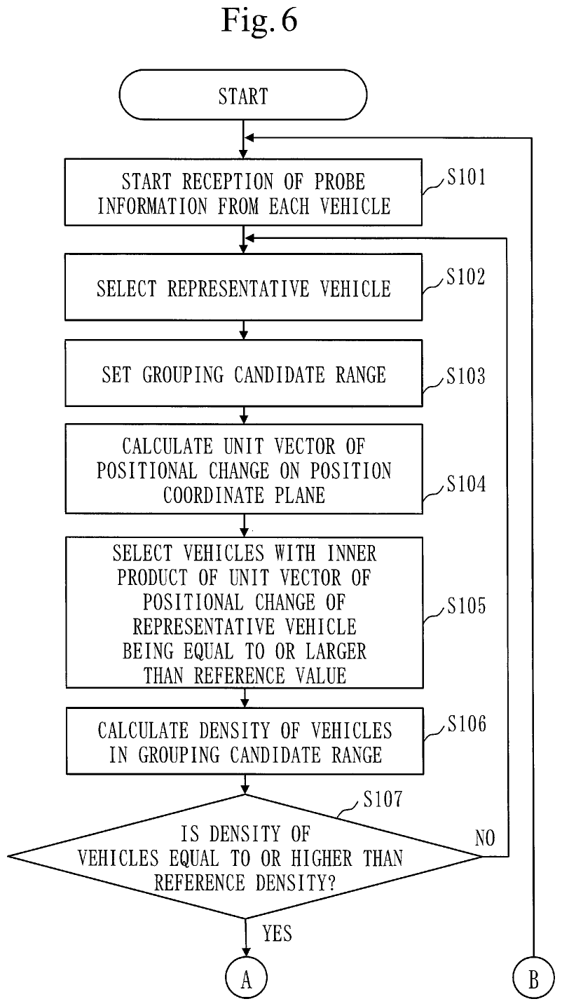

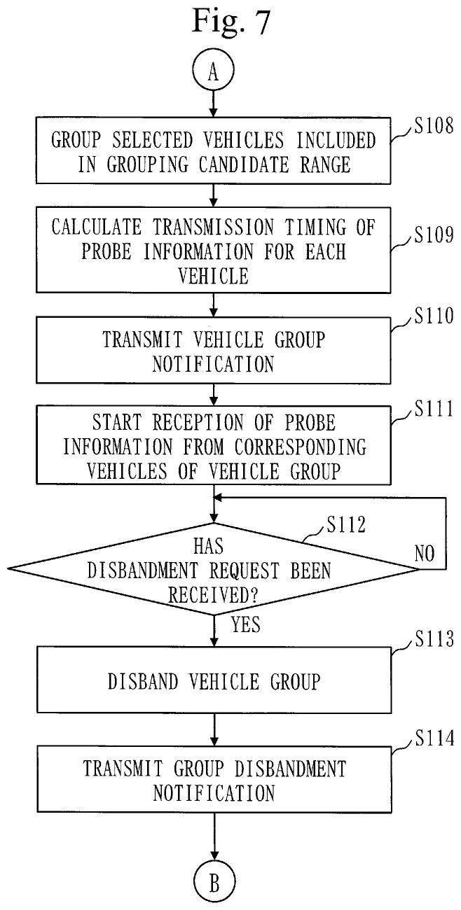

First, operations of the server device 110 are described. FIG. 6 and FIG. 7 are flowcharts illustrating operations of the server device 110.

First, the reception unit 111 starts reception of probe information from respective on-vehicle devices 210 (Step S101). Until Step S111 described below is performed, the reception unit 111 repeatedly receives probe information from the respective on-vehicle devices 210 with a certain reception interval.

Each time probe information is received by the reception unit 111, the probe-information management unit 112 stores the received probe information in the storage unit 116.

Next, the grouping unit 1131 selects an arbitrary vehicle as a representative vehicle, from among a plurality of vehicles travelling in the same direction (Step S102).

Next, the grouping unit 1131 sets a range within a predetermined distance from the representative vehicle, as a grouping candidate range (Step S103).

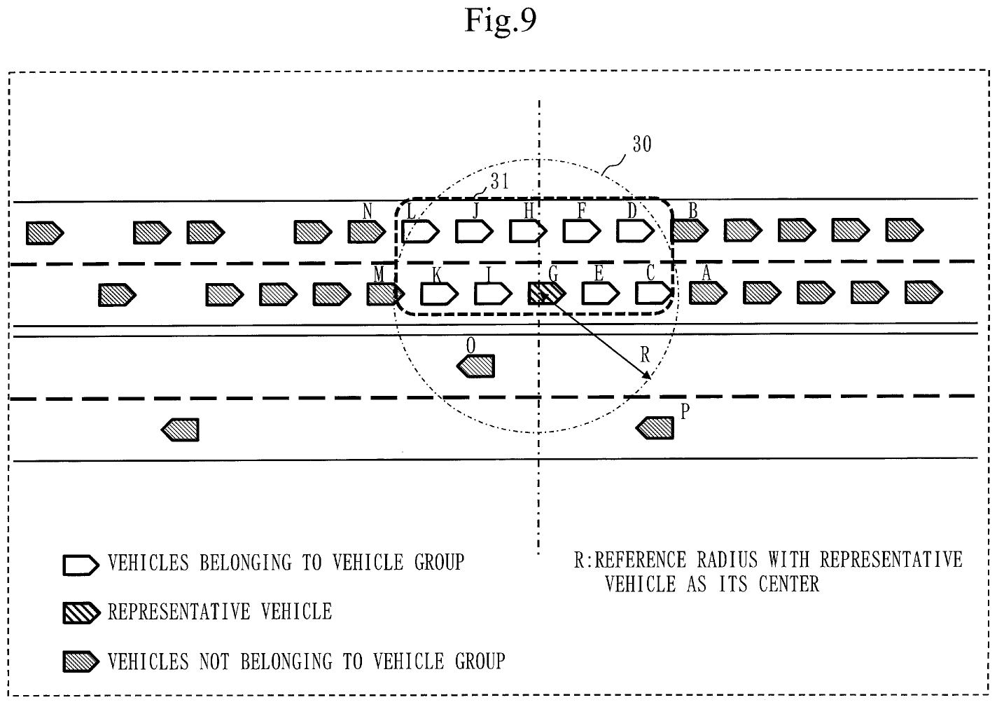

FIG. 9 illustrates a setting example of the grouping candidate range.

In the example of FIG. 9, a vehicle G is the representative vehicle. The grouping unit 1131 then sets the inside of a circle whose center is the position of the vehicle G being the representative vehicle and whose radius is a predetermined reference radius R, as a group candidate range 30.

Next, the grouping unit 1131 calculates a unit vector of a positional change on a position coordinate plane of the respective vehicles 200 in order to obtain the travelling direction of the respective vehicles 200 within the group candidate range 30 (Step S104).

Specifically, the grouping unit 1131 measures the position of the respective vehicles 200 within the group candidate range 30 with a reference time interval. For example, the grouping unit 1131 measures the position of a vehicle D at a time t0 and the position of the vehicle D at a time t1. The interval between the time t0 and the time t1 is the reference time interval. The grouping unit 1131 then calculates a unit vector of a positional change of the vehicle D on the position coordinate plane on the basis of a change from the position at the time to to the position at the time t1. The grouping unit 1131 performs this procedure on each of the vehicles 200 within the group candidate range 30.

Next, the grouping unit 1131 selects vehicles 200 with an inner product of a unit vector of a positional change equal to or larger than a reference value (Step S105).

Specifically, the grouping unit 1131 calculates, with respect to each of the vehicles 200, an inner product between a unit vector of a positional change of the vehicle 200 and a unit vector of a positional change of the representative vehicle. The grouping unit 1131 then selects vehicles 200 with a unit vector of a positional change having an inner product with respect to the unit vector of the positional change of the representative vehicle equal to or larger than the reference value. Due to this process, the grouping unit 1131 can select vehicles in the same travelling direction.

Next, the grouping unit 1131 calculates the density of the vehicles 200 that are selected in Step S105 in the grouping candidate range 30 (Step S106).

Specifically, the grouping unit 1131 obtains the density by dividing the number of the vehicles 200 selected in Step S105 by the area of the grouping candidate range 30.

The grouping unit 1131 then compares the density of the vehicles 200 obtained in Step S106 with a predetermined reference density (Step S107).

When the density of the vehicles 200 obtained in Step S106 is lower than the reference density, the grouping unit 1131 returns to Step S102 and selects another vehicle 200 as the representative vehicle.

Meanwhile, when the density of the vehicles 200 obtained in Step S106 is equal to or higher than the reference density, the grouping unit 1131 determines that a traffic-congested state has occurred, and groups the selected vehicles 200 included in the grouping candidate range 30 (Step S108).

That is, the grouping unit 1131 forms a vehicle group with the selected vehicles 200 included in the grouping candidate range 30.

In the example of FIG. 9, the grouping unit 1131 includes, in a vehicle group, a vehicle C, the vehicle D, a vehicle E, a vehicle F, a vehicle H, a vehicle I, a vehicle L, and a vehicle K that are included in the grouping candidate range 30 and travelling in the same direction as the travelling direction of the vehicle G, as well as the vehicle G. That is, the vehicles 200 positioned within the range surrounded by the broken line of reference sign 31 are included in the vehicle group.

Next, the grouping unit 1131 calculates a transmission timing of probe information for each of the vehicles 200 included in the vehicle group (Step S109).

In the present embodiment, it is assumed that the respective vehicles 200 included in a vehicle group transmit probe information in sequence. In the example of FIG. 9, for example, probe information is transmitted in the order of the vehicle C, the vehicle D, the vehicle E, the vehicle F, the vehicle G, the vehicle H, the vehicle I, the vehicle K, and the vehicle L, and it is assumed that at the timing when any of the vehicles is transmitting its probe information, other vehicles do not transmit their probe information.

First, the grouping unit 1131 reduces the transmission frequency of the probe information of the respective vehicles 200 that belong to the vehicle group. Specifically, the grouping unit 1131 adjusts the transmission frequency of the respective vehicles 200 so that the transmission frequency of the probe information in the vehicle group and the transmission frequency of the probe information of the respective vehicles 200 before forming the vehicle group become the same. That is, while assuming that the transmission frequency of the probe information of the respective vehicles 200 before forming the vehicle group is T [times/second] and the number of the vehicles 200 included in the vehicle group is n, the grouping unit 1131 adjusts the transmission frequency of the probe information of the respective vehicles 200 after forming the vehicle group to be T/n [times/second]. The grouping unit 1131 then sets a transmission order and a transmission timing such that the respective vehicles 200 transmit their probe information in sequence with this transmission frequency.

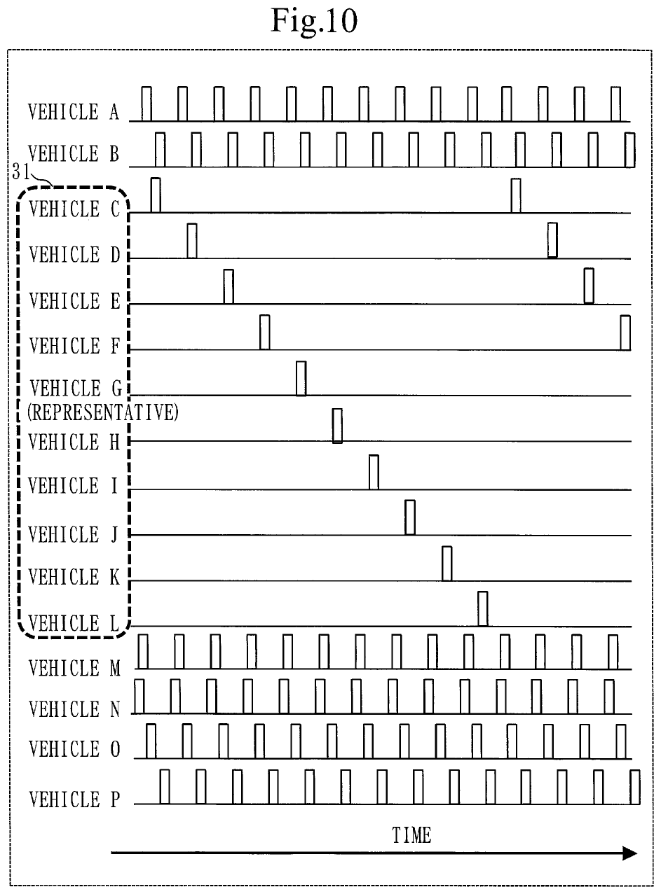

FIG. 10 illustrates a transmission status of probe information to the server device 110 from the on-vehicle devices 210 of the respective vehicles 200.

In FIG. 10, since the vehicle C to the vehicle L belong to a vehicle group, the vehicle C to the vehicle L transmit their probe information in sequence at a limited transmission timing. The number of the vehicle 200 that transmits probe information at each transmission timing is always one.

Meanwhile, each of the vehicle A, the vehicle B, the vehicle M, the vehicle N, the vehicle O, and the vehicle P that do not belong to the vehicle group transmits their probe information at all the transmission timings.

Next, the grouping unit 1131 generates a vehicle group notification, and the transmission unit 115 transmits the vehicle group notification to the respective on-vehicle devices 210.

The vehicle group information notifies each on-vehicle device 210 of a fact that the vehicle 200 on which each on-vehicle devices 210 is mounted belongs to a vehicle group with other vehicles 200 that are travelling in the same direction as the travelling direction of the vehicle 200. The vehicle group notification notifies each on-vehicle device 210 of a transmission timing (hereinafter, “selected transmission timing”) that is a timing at which each on-vehicle device 210 is supposed to transmit its probe information.

Like the vehicle C to the vehicle L illustrated in FIG. 10, the on-vehicle device 210 of each vehicle 200 belonging to the vehicle group transmits, probe information only at the selected transmission timing, upon reception of the vehicle group notification.

The grouping unit 1131 generates vehicle group information indicating identifiers of the vehicles 200 belonging to the vehicle group and a transmission order, and stores the generated vehicle group information in the storage unit 116.

As for the vehicles 200 belonging to the vehicle group, the reception unit 111 starts reception of probe information only from corresponding vehicles 200 of the vehicle group (Step S111). That is, as for the vehicles 200 belonging to the vehicle group, the reception unit 111 receives probe information only from the on-vehicle device 210 for which the selected transmission timing has arrived.

Until Step S111 is performed after Step S114 described later is performed, as for the vehicles 200 belonging to the vehicle group, the reception unit 111 repeats reception of probe information only from corresponding vehicles 200 of the vehicle group.

Next, the group disbandment unit 1132 determines whether the reception unit 111 has received a disbandment request from the on-vehicle device 210 of the vehicle 200 belonging to the vehicle group (Step S112).

If the reception unit 111 does not receive a disbandment request, the group disbandment unit 1132 continues the process of Step S112.

Meanwhile, if the reception unit 111 receives a disbandment request, the group disbandment unit 1132 disbands the vehicle group (Step S113). Specifically, the group disbandment unit 1132 generates a group disbandment notification. The group disbandment notification is a message for notifying the on-vehicle devices 210 of the vehicles 200 in the vehicle group of disbandment of the vehicle group.

Next, the transmission unit 115 transmits the group disbandment notification to the on-vehicle devices 210 of all the vehicles 200 in the vehicle group (Step S114).

Thereafter, the reception unit 111 starts reception of probe information individually from the on-vehicle devices 210 of the vehicles 200 that have belonged to the disbanded vehicle group (Step S101).

That is, after the vehicle group is disbanded, each of the vehicle C to the vehicle L transmits its probe information at all the transmission timings, like the vehicle A, the vehicle B, the vehicle M, the vehicle N, the vehicle O, and the vehicle P in FIG. 10.

Further, the group disbandment unit 1132 discards the vehicle group information stored in the storage unit 116.

In this manner, while the vehicle group is maintained, the reception unit 111 receives probe information from an on-vehicle device 210 among a plurality of on-vehicle devices 210 at each timing for receiving the probe information, which arrives repeatedly. Meanwhile, after the vehicle group is disbanded, the reception unit 111 receives the probe information from each of the plurality of on-vehicle devices 210 at each timing for receiving the probe information.

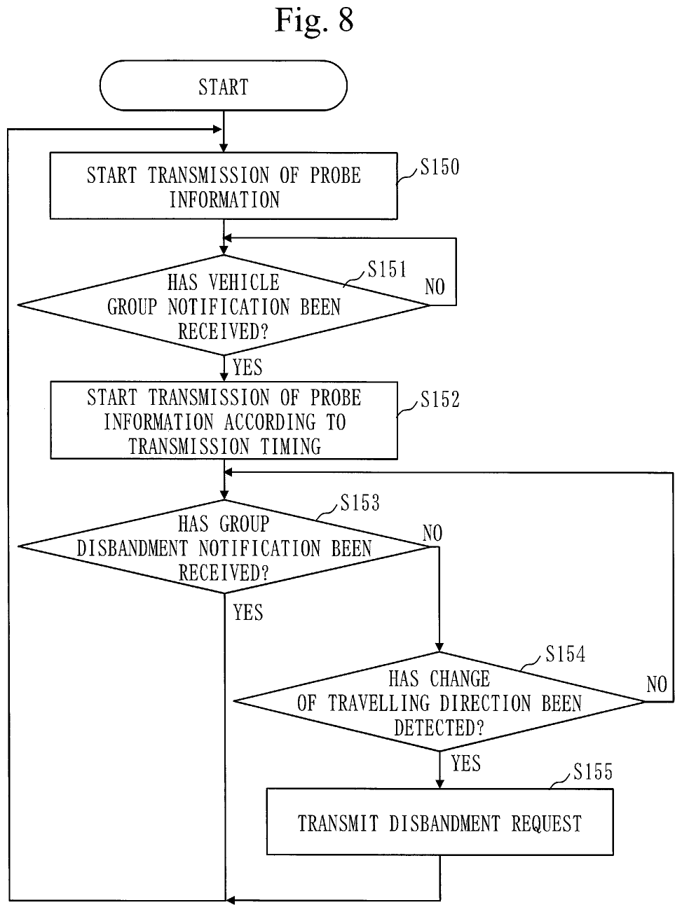

Next, operations of the on-vehicle device 210 are described. FIG. 8 is a flowchart illustrating operations of the on-vehicle device 210.

First, the probe-information management unit 212 starts transmission of probe information to the server device 110 (Step S150). That is, the probe-information management unit 212 reads probe information from the storage unit 217 and transmits the read probe information to the server device 110 via the transmission unit 214. Until performing Step S152 described later, the probe-information management unit 212 repeatedly transmits probe information with a certain transmission interval. Concurrently, the probe-information acquisition unit 211 acquires probe information and the probe-information management unit 212 stores the probe information in the storage unit 217.

Next, the probe-information management unit 212 determines whether the reception unit 213 has received a vehicle group notification (Step S151).

When the reception unit 213 has not received the vehicle group notification, the probe-information management unit 212 continues the process of Step S151.

When the reception unit 213 has received the vehicle group notification, the probe-information management unit 212 starts transmission of probe information to the server device 110 via the transmission unit 214 according to a transmission timing notified by the vehicle group notification (Step S152). That is, like the vehicle C to the vehicle L illustrated in FIG. 10, the probe-information management unit 212 transmits probe information to the server device 110 only at the transmission timing notified by the vehicle group notification.

Until Step S153 described later becomes YES and Step S150 is performed, the probe-information management unit 212 transmits probe information to the server device 110 only at the transmission timing notified by the vehicle group information.

Next, the probe-information management unit 212 determines whether the reception unit 111 has received a group disbandment notification from the server device 110 (Step S153).

When the reception unit 111 has received the group disbandment notification, the probe-information management unit 212 starts transmission of probe information at each transmission timing (Step S150).

That is, since the vehicle group has been disbanded, like the vehicle A, the vehicle B, the vehicle M, the vehicle N, the vehicle O, and the vehicle P, the on-vehicle devices 210 of the vehicles 200 that have belonged to the vehicle group respectively transmit their probe information at all the transmission timings.

When the reception unit 111 has not received the group disbandment notification, the detection unit 215 determines whether a change of the travelling direction of the vehicle 200 is detected (Step S154).

Specifically, the detection unit 215 measures the positions of the vehicles 200 with a reference time interval. For example, the detection unit 215 of the on-vehicle device 210 of the vehicle D measures the position of the vehicle D at the time t0 and the position of the vehicle D at the time t1. The interval between the time t0 and the time t1 is the reference time interval. Subsequently, the detection unit 215 calculates a unit vector of a positional change of the vehicle D on a position coordinate plane is calculated on the basis of a change between the position at the time t0 and the position at the time t1. The detection unit 215 then calculates the unit vector of the positional change of the vehicle D on the position coordinate plane by using the position at a time t-2 and the position at a time t-1. The interval between the time t-2 and the time t-1 is the reference time interval. The interval between the time to or the time t1 and the time t-2 or the time t-1 is another reference time interval. Further, the detection unit 215 calculates an inner product between a unit vector of a positional change between the time t0 and the time t1 and an inner product of a unit vector of a positional change between the time t-2 and the time t-1. When the inner product between the unit vector of the positional change between the time t0 and the time t1 and the unit vector of the positional change between the time t-2 and the time t-1 is less than a reference value, it is determined that the travelling direction of a vehicle 200 has changed due to any of a left turn, a right turn, and a U-turn. The vehicle 200 detected in Step S154 as a vehicle having changed its travelling direction is also referred to as a quitting vehicle.

When the detection unit 205 detects a change of the travelling direction of the vehicle 200, the detection unit 215 generates a disbandment request and transmits the disbandment request to the server device 110 via the transmission unit 214 (Step S155). Thereafter, Step S150 is performed and the probe-information management unit 212 starts transmission of probe information at each transmission timing.

***Effects of Embodiment***

In the present embodiment, upon reception of a disbandment request from the on-vehicle device 210 of a quitting vehicle, the server device 110 disbands a vehicle group. Therefore, according to the present embodiment, when a vehicle 200 in the vehicle group starts to travel in a direction different from that of other vehicles 200 in a vehicle group, the server device 110 can securely disband the vehicle group and switch to collection of probe information from each of the vehicles 200.

Further, in the present embodiment, the server device 110 can determine whether a traffic-congested state has occurred by calculating the density of the vehicles 200 within the grouping candidate range 30.

In the present embodiment, when the server device 110 determines that a traffic-congested state has occurred, the server device 110 forms a vehicle group with the vehicles 200 within the grouping candidate range 30, and reduces the transmission volume of probe information from the on-vehicle devices 210 of the vehicles 200 belonging to the vehicle group. Accordingly, the transmission volume of probe information at the time of a traffic congestion can be suppressed.

In the present embodiment, the on-vehicle devices 210 of the respective vehicles 200 within a vehicle group transmit their probe information in sequence. Accordingly, it is possible to avoid a situation in which the probe information accumulated in the server device 110 is occupied by the probe information of a specific vehicle 200.

In the present embodiment, the server device 110 calculates an inner product between a unit vector of a positional change on a position coordinate plane of a representative vehicle and a unit vector of a positional change on a position coordinate plane of the respective vehicles 200 in the grouping candidate range 30, so that only vehicles 200 travelling in the same direction as that of the representative vehicle are included in the vehicle group. Accordingly, it is possible to form a vehicle group while distinguishing vehicles 200 travelling upbound from vehicles 200 travelling downbound. Therefore, it is possible to avoid a case where vehicles 200 travelling in a direction different from that of the representative vehicle at an intersection, a junction, a branching point, and the like are erroneously included in the vehicle group.

In the present embodiment, it has been described that, after forming a vehicle group, the respective vehicles 200 belonging to the vehicle group transmit their probe information to the server device 110 in sequence. Instead of this, it is also possible that only a representative vehicle in the vehicle group transmits its probe information to the server device 110 on behalf of other vehicles.

### Second Embodiment

In the present embodiment, there is described an example in which the grouping unit 1131 of the server device 110 selects a vehicle 200 that transmits probe information, for each lane on a multiple-lane road. The vehicle 200 selected by the grouping unit 1131 for each lane is referred to as a selected vehicle.

In the present embodiment, the grouping unit 1131 designates, for each selected vehicle, a probe-information acquisition device that acquires probe information from among a plurality of probe-information acquisition devices mounted in respective selected vehicles. In the present embodiment, the grouping unit 1131 notifies the on-vehicle devices of the respective selected vehicles of the designated probe-information acquisition device. In the present embodiment, it is assumed that the probe-information acquisition device is a camera that functions as the sensor device 26 illustrated in FIG. 4. In the present embodiment, for example, it is assumed that a camera is mounted on both the left and right sides of the selected vehicles. The grouping unit 1131 instructs a selected vehicle travelling in the left lane in the travelling direction on a two-track road to transmit probe information (images) captured by a left-side camera. Further, the grouping unit 1131 instructs a selected vehicle travelling in the right lane in the travelling direction on the two-track road to transmit probe information (images) captured by a right-side camera.

***Descriptions of Configurations***

The system configuration example of a probe-information collecting system according to the present embodiment is identical to that illustrated in FIG. 1. Further, the hardware configuration example of the server device 110 according to the present embodiment is identical to that illustrated in FIG. 2. The functional configuration example of the server device 110 according to the present embodiment is identical to that illustrated in FIG. 3. The hardware configuration example of the on-vehicle device 210 according to the present embodiment is identical to that illustrated in FIG. 4. The functional configuration example of the on-vehicle device 210 according to the present embodiment is identical to that illustrated in FIG. 5.

In the following descriptions, differences from the first embodiment are mainly described. Matters not described in the following descriptions are identical to those of the first embodiment.

***Descriptions of Operations***

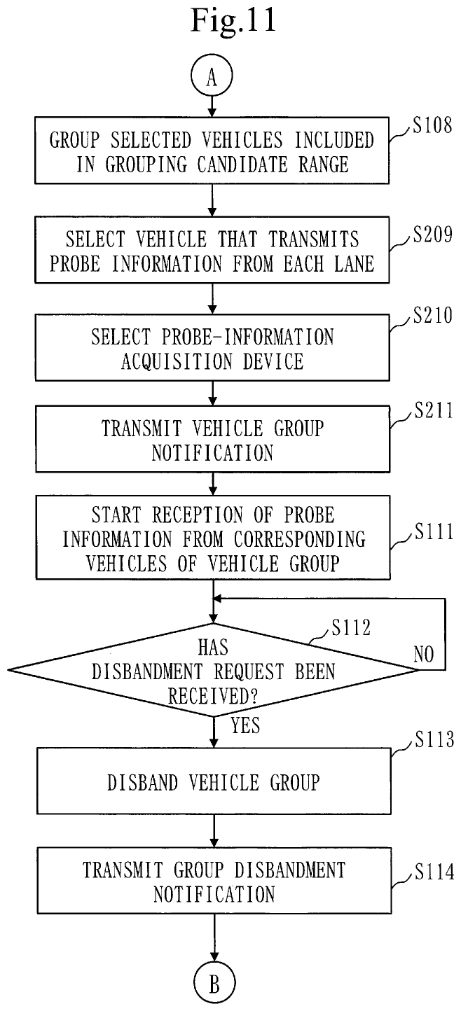

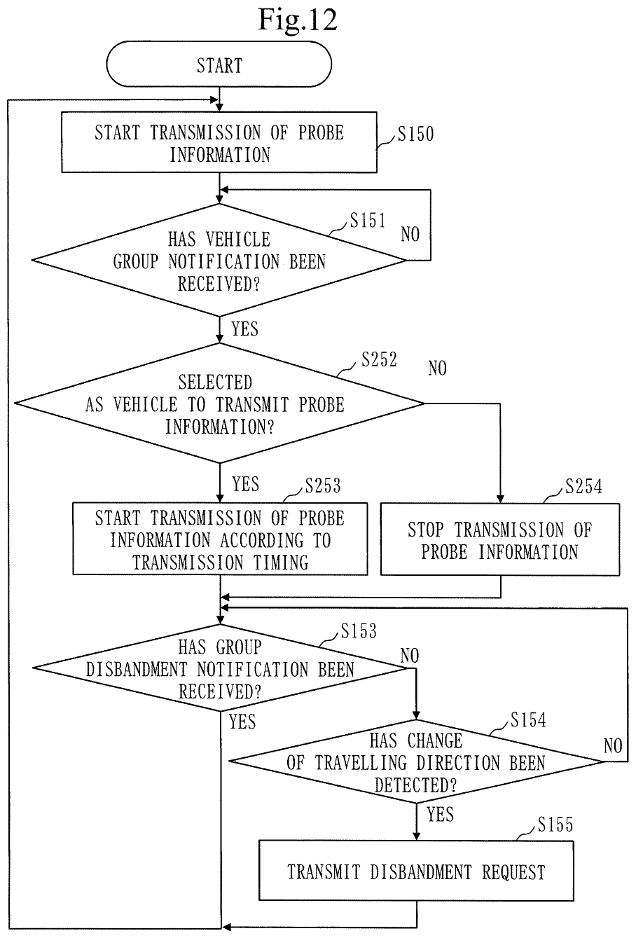

Operations of the on-vehicle device 210 according to the present embodiment are described first. FIG. 11 is a flowchart illustrating operations of the server device 110 according to the present embodiment.

After Steps S101 to S107 illustrated in FIG. 6 are performed, the group disbandment unit 1132 performs Step S108. Step S108 is identical to that described in the first embodiment, and thus explanations thereof are omitted.

Next, the grouping unit 1131 selects a vehicle 200 that transmits probe information for each lane (Step S209). As described above, a vehicle 200 selected for each lane is referred to as a selected vehicle.

As illustrated in FIG. 9, when the vehicle C to the vehicle L are grouped, the group disbandment unit 1132 selects, for example, the vehicle H as a selected vehicle among the vehicle D, the vehicle F, the vehicle H, the vehicle J, and the vehicle L that are travelling in the left lane in the travelling direction. Further, the grouping unit 1131 selects, for example, the vehicle G as a selected vehicle among the vehicle C, the vehicle E, the vehicle G, the vehicle I, and the vehicle K that are travelling in the right lane in the travelling direction.

Next, the grouping unit 1131 selects a probe-information acquisition device for each of the selected vehicles (Step S210).

In the example of FIG. 9, the group disbandment unit 1132 selects a left-side camera for the vehicle H that is travelling in the left lane in the travelling direction. Further, the group disbandment unit 1132 selects a right-side camera for the vehicle G that is travelling in the right lane.

Next, the grouping unit 1131 generates a vehicle group notification and the transmission unit 115 transmits the vehicle group notification to the respective on-vehicle devices 210 (Step S211).

In the present embodiment, the grouping unit 1131 generates the vehicle group notification notifying that the vehicle H and the vehicle G are selected as selected vehicles, the vehicle H transmits only images captured by the left-side camera as probe information, and the vehicle G transmits only images captured by the right-side camera as probe information.

Subsequently, processes in Step S111 onwards described with reference to FIG. 7 are performed. As described above, in Step S111, the probe information received by the reception unit 111 from the on-vehicle device 210 of the vehicle H is images captured by the left-side camera of the vehicle H, and the probe information received by the reception unit 111 from the on-vehicle device 210 of the vehicle G is images captured by the right-side camera of the vehicle G.

Operations of the on-vehicle device 210 according to the present embodiment are described next. FIG. 12 is a flowchart illustrating operations of the on-vehicle device 210 according to the present embodiment.

Step S150 and Step S151 are identical to those described in FIG. 8, and thus explanations thereof are omitted.

When the reception unit 213 receives a vehicle group notification, the probe-information management unit 212 determines whether the vehicle 200 on which the on-vehicle device 210 is mounted is selected as a selected vehicle in the received vehicle group notification (Step S252).

When the vehicle 200 on which the on-vehicle device 210 is mounted is selected as the selected vehicle, the process proceeds to Step S253, and when the vehicle 200 on which the on-vehicle device 210 is mounted is not selected as the selected vehicle, the process proceeds to Step S254. In the example of FIG. 9, as for the vehicle H and the vehicle G, the process proceeds to Step S253, and as for the other vehicles, the process proceeds to Step S254.

When the vehicle on which the on-vehicle device 210 is mounted is selected as the selected vehicle, the probe-information management unit 212 starts transmission of probe information to the server device 110 according to a transmission timing (Step S253). That is, in the vehicle H, the probe-information management unit 212 transmits images captured by the left-side camera as probe information to the server device 110 via the transmission unit 214. In the vehicle H, the probe-information management unit 212 transmits images captured by the right-side camera as probe information to the server device 110 via the transmission unit 214.

Meanwhile, when the vehicle 200 on which the on-vehicle device 210 is mounted is not selected as the selected vehicle, the probe-information management unit 212 stops transmission of probe information (Step S254).

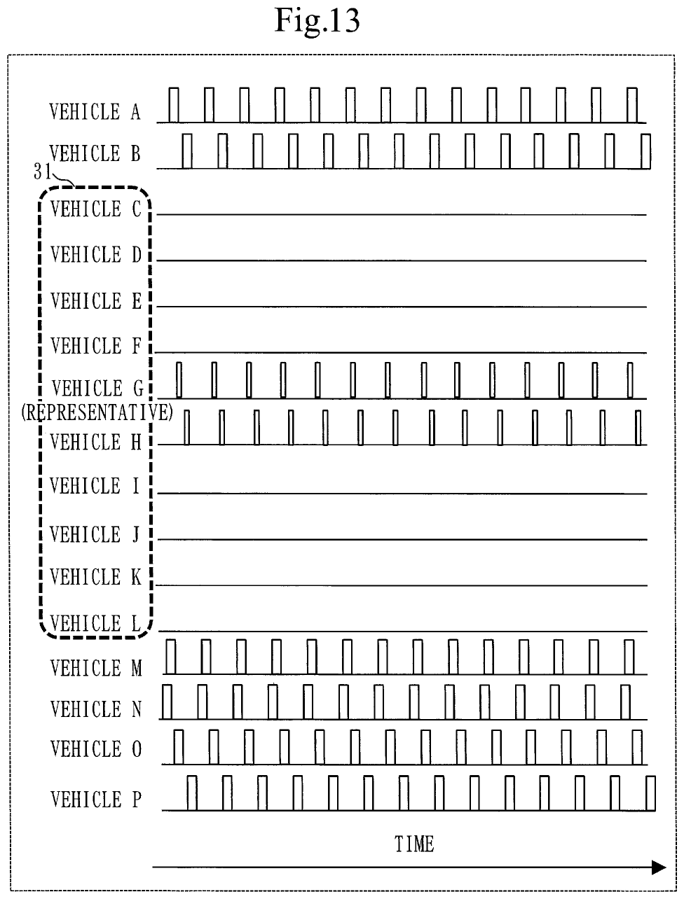

FIG. 13 illustrates a transmission status of probe information from the on-vehicle devices 210 of the respective vehicles 200 to the server device 110 after Step S253 and Step S254 are performed.

In FIG. 13, the vehicle C to the vehicle L belong to a vehicle group, and only the vehicle G and the vehicle H which are the selected vehicles, transmit their probe information. The vehicle C to the vehicle E and the vehicle Ito the vehicle L have been stopping transmission of their probe information.

After Step S253 or Step S254, processes in Step S153 onwards are performed. Processes in Step S153 onwards are identical to those described in FIG. 8, and thus explanations thereof are omitted.

***Descriptions of Effects of Embodiment***

As described above, in the present embodiment, the server device 110 selects a vehicle that transmits probe information for each lane as a selected vehicle from among a plurality of vehicles travelling on a multiple-lane road. Accordingly, the server device 110 can acquire probe information for each lane, so that it is possible to perform detailed monitoring in, accident monitoring by cameras and to suppress the transmission volume of probe information, for example.

Further, in the present embodiment, the server device 110 selects a probe-information acquisition device for each selected vehicle and causes the on-vehicle device 210 to transmit only probe information acquired by the selected probe-information acquisition device. Accordingly, for example, it is possible to acquire minimum required images in accident monitoring by cameras and to suppress the transmission volume of probe information.

In the above descriptions, there has been described an example in which the on-vehicle device 210 of a selected vehicle transmits camera images as probe information to the server device 110. The probe information to be transmitted to the server device 110 is not limited to the camera images, and can be sound picked up by a microphone and point group data collected by a radar.

In the above descriptions, there has been described an example in which the on-vehicle device 210 of a selected vehicle in the left lane transmits images captured by a left-side camera as probe information to the server device 110, and the on-vehicle device 210 of a selected vehicle in the right lane transmits images captured by a right-side camera as probe information to the server device 110. Instead of this configuration, the on-vehicle device 210 of the selected vehicle in the left lane may transmit images captured by the right-side camera as probe information to the server device 110 and the on-vehicle device 210 of the selected vehicle in the right lane may transmit images captured by the left-side camera as probe information to the server device 110. Further, both the on-vehicle device 210 of the selected vehicle in the left lane and the on-vehicle device 210 of the selected vehicle in the right lane may transmit only images captured by their left-side cameras or only images captured by their right-side cameras to the server device 110. The server device 110 can arbitrarily select a combination between the lane and the camera position.

Furthermore, as for roads with three or more lanes, the on-vehicle device 210 of a selected vehicle travelling in a lane other than the leftmost lane and the rightmost lane may transmit images captured by both left and right cameras as probe information to the server device 110. The on-vehicle device 210 of a selected vehicle travelling in a lane other than the leftmost lane and the rightmost lane may transmit images captured by either one of left and right cameras as probe information to the server device 110.

In the above descriptions, the server device 110 selects a selected vehicle for each lane and causes only the selected vehicle to transmit its probe information. Instead of this, the server device 110 may cause the on-vehicle devices 210 of a plurality of vehicles 200 to transmit their probe information in sequence for each lane. That is, the server device 110 may cause the on-vehicle devices 210 of a plurality of vehicles 200 travelling in each lane to transmit their probe information in sequence similarly to the transmission mode of probe information employed in the vehicle C to the vehicle L in FIG. 10.

While embodiments of the present invention have been described above, the two embodiments may be carried out in combination.

Alternatively, one of the two embodiments can be partially carried out.

Alternatively, the two embodiments can be carried out in combination.

The present invention is not limited to these embodiments and can be variously modified as necessary.

***Descriptions of Hardware Configuration***

Finally, hardware configurations of the server device 110 and the on-vehicle device 210 are explained supplementarily.

Each of the processor 10 and the processor 20 is an IC (Integrated Circuit) that performs processing.

Each of the processor 10 and the processor 20 is a CPU (Central Processing Unit), a DSP (Digital Signal Processor), or the like.

Each of the memory 11 and the memory 21 is a RAM (Random Access Memory).

Each of the storage device 12 and the storage device 22 is a ROM (Read Only Memory), a flash memory, an HDD (Hard Disk Drive), or the like.

Each of the communication device 15 and the communication device 25 includes a receiver that receives data and a transmitter that transmits data.

Each of the communication device 15 and the communication device 25 is, for example, a communication chip or a NIC (Network Interface Card).

Further, an OS (Operating System) is stored in each of the storage device 12 and the storage device 22.

At least a part of the OS is executed by the processor 10 and the processor 20.

The processor 10 executes programs for realizing the functions of the reception unit 111, the probe-information management unit 112, the group management unit 113, the control unit 114, and the transmission unit 115 while executing at least a part of the OS.

The processor 10 executes the OS, thereby task management, memory management, file management, communication control and the like are performed.

Further, the processor 20 executes programs for realizing the functions of the probe-information acquisition unit 211, the probe-information management unit 212, the reception unit 213, the transmission unit 214, the detection unit 215, and the control unit 216 while executing at least a part of the OS.

The processor 20 executes the OS, thereby task management, memory management, file management, communication control and the like are performed.

At least any of information, data, signal values, and variable values indicating results of processing by the reception unit 111, the probe-information management unit 112, the group management unit 113, the control unit 114, and the transmission unit 115 is stored at least in any of the storage device 12, and a register and a cache memory in the processor 10.

Programs for realizing the functions of the reception unit 111, the probe-information management unit 112, the group management unit 113, the control unit 114, and the transmission unit 115 may be stored in a portable storage medium such as a magnetic disk, a flexible disk, an optical disk, a compact disk, a Blu-ray (registered trademark) disk, and a DVD.

At least any of information, data, signal values, and variable values indicating results of processing by the probe-information acquisition unit 211, the probe-information management unit 212, the reception unit 213, the transmission unit 214, the detection unit 215, and the control unit 216 is stored at least in any of the storage device 22, and a register and a cache memory in the processor 20.

Programs for realizing the functions of the probe-information acquisition unit 211, the probe-information management unit 212, the reception unit 213, the transmission unit 214, the detection unit 215, and the control unit 216 may be stored in a portable storage medium such as a magnetic disk, a flexible disk, an optical disk, a compact disk, a Blu-ray (registered trademark) disk, and a DVD.

The “unit” of the reception unit 111, the probe-information management unit 112, the group management unit 113, the control unit 114, the transmission unit 115, the probe-information acquisition unit 211, the probe-information management unit 212, the reception unit 213, the transmission unit 214, the detection unit 215, and the control unit 216 can be replaced with “circuit”, “step”, “procedure”, or “process”.

Each of the server device 110 and the on-vehicle device 210 may be realized by an electronic circuit such as a logic IC (Integrated Circuit), a GA (Gate Array), an ASIC (Application Specific Integrated Circuit), and an FPGA (Field-Programmable Gate Array).

In this case, each of the reception unit 111, the probe-information management unit 112, the group management unit 113, the control unit 114, the transmission unit 115, the probe-information acquisition unit 211, the probe-information management unit 212, the reception unit 213, the transmission unit 214, the detection unit 215, and the control unit 216 is realized as a part of the electronic circuit.

The processors and the electronic circuit described above are also collectively referred to as processing circuitry.

### REFERENCE SIGNS LIST

10: processor; 11: memory; 12: storage device; 13: input device; 14: output device; 15: communication device; 20: processor; 21: memory; 22: storage device; 23: input device; 24: output device; 25: communication device; 26: sensor device; 27: GPS reception device; 30: grouping candidate range; 100: probe-information collection center; 110: server device; 111: reception unit; 112: probe-information management unit; 113: group management unit; 1131: grouping unit; 1132: group disbandment unit; 114: control unit; 115: transmission unit; 116: storage unit; 200: vehicle; 210: on-vehicle device; 211: probe-information acquisition unit; 212: probe-information management unit; 213: reception unit; 214: transmission unit; 215: detection unit; 216: control unit; 217: storage unit

1. An information processing device comprising:
processing circuitry
to group a plurality of vehicles travelling in a same direction on a multiple-lane road, on each of which an on-vehicle device is mounted, to select a vehicle from among the plurality of vehicles, for each lane, and to notify each of a plurality of on-vehicle devices of the plurality of vehicles of a fact that a vehicle on which each on-vehicle device is mounted belongs to a vehicle group;
to receive a disbandment request for requesting disbandment of the vehicle group, from an on-vehicle device of a quitting vehicle whose travelling direction has become different from that of other vehicles of the plurality of vehicles, among the plurality of on-vehicle devices; and
to disband the vehicle group when the disbandment request is received,
wherein while the vehicle group is maintained, at each timing for receiving probe information, the processing circuitry receives the probe information from an on-vehicle device of a selected vehicle that is a vehicle selected for each lane, for each lane, and after the vehicle group is disbanded, the processing circuitry receives the probe information from each of the plurality of on-vehicle devices at each timing for receiving the probe information.

2. (canceled)

3. The information processing device according to claim 1,
wherein the processing circuitry sets a transmission order of the probe information, to the plurality of on-vehicle devices, and
while the vehicle group is maintained, at each timing for receiving the probe information, the processing circuitry receives the probe information from a corresponding on-vehicle device according to the transmission order.

4. (canceled)

5. The information processing device according to claim 1,
wherein the processing circuitry receives from an on-vehicle device of each selected vehicle, the probe information acquired by a probe-information acquisition device that is designated from among a plurality of probe-information acquisition devices mounted on each selected vehicle.

6. The information processing device according to claim 5,
wherein the processing circuitry designates a probe-information acquisition device which acquires the probe information from among the plurality of probe-information acquisition devices for each selected vehicle, and notifies the on-vehicle device of each selected vehicle of the probe-information acquisition device designated.

7. The information processing device according to claim 1,
wherein the processing circuitry designates an arbitrary vehicle travelling in a specific direction as a representative vehicle, calculates a density of vehicles that are included in a grouping candidate range being within a predetermined distance from the representative vehicle, the vehicles travelling in the specific direction, and when the density calculated is equal to or higher than a reference density, the processing circuitry groups a plurality of vehicles that are travelling in the specific direction and included in the grouping candidate range, the plurality of vehicles including the representative vehicle.

8-10. (canceled)

11. An information processing method comprising:
grouping a plurality of vehicles travelling in a same direction on a multiple-lane road, on each of which an on-vehicle device is mounted, selecting a vehicle from among the plurality of vehicles, for each lane, and notifying each of a plurality of on-vehicle devices of the plurality of vehicles of a fact that a vehicle on which each on-vehicle device is mounted belongs to a vehicle group;
receiving a disbandment request for requesting disbandment of the vehicle group, from an on-vehicle device of a quitting vehicle whose travelling direction has become different from that of other vehicles of the plurality of vehicles, among the plurality of on-vehicle devices;
disbanding the vehicle group when the disbandment request is received; and
receiving probe information from an on-vehicle device of a selected vehicle that is a vehicle selected for each lane, for each lane, at each timing for receiving the probe information, while the vehicle group is maintained, and receiving the probe information from each of the plurality of on-vehicle devices at each timing for receiving the probe information, after the vehicle group is disbanded.

12. (canceled)

13. A non-transitory computer readable medium storing an information processing program which causes a computer to execute:
a grouping process of grouping a plurality of vehicles travelling in a same direction on a multiple-lane road, on each of which an on-vehicle device is mounted, of selecting a vehicle from among the plurality of vehicles, for each lane, and of notifying each of a plurality of on-vehicle devices of the plurality of vehicles of a fact that a vehicle on which each on-vehicle device is mounted belongs to a vehicle group;
a disbandment request receiving process of receiving a disbandment request for requesting disbandment of the vehicle group, from an on-vehicle device of a quitting vehicle whose travelling direction has become different from that of other vehicles of the plurality of vehicles, among the plurality of on-vehicle devices;
a group disbanding process of disbanding the vehicle group when the disbandment request is received by the receiving process; and
a probe information receiving process of receiving probe information from an on-vehicle device of a selected vehicle that is a vehicle selected for each lane by the grouping process, for each lane, at each timing for receiving the probe information, while the vehicle group is maintained, and of receiving the probe information from each of the plurality of on-vehicle devices at each timing for receiving the probe information, after the vehicle group is disbanded.

14. (canceled)
